(19) United States
(12) Patent Application Publication
(10) Pub. No.: US 2009/0193139 A1
(43) Pub. Date: Jul. 30, 2009

(54) COMMUNICATION APPARATUS, COMMUNICATION SYSTEM, COMMUNICATION METHOD AND PROGRAM

(76) Inventors: Hironaga SANO, Kanagawa (JP); Hiroyuki FUJINAGA, Kanagawa (JP); Tetsuo UMEDA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/361,297

(22) Filed: Jan. 28, 2009

(30) Foreign Application Priority Data
Jan. 29, 2008 (JP) P2008-018120

(51) Int. Cl. G06F 15/16

(52) U.S. Cl. 709/232

(57) ABSTRACT

A communication apparatus includes a physical layer to perform signal transmission/reception with another communication end, and a data transfer section (DTL) to connect an upper level user application and the physical layer. The DTL includes a profile ID addition section to add a profile ID indicating the type of a data file to a transmission data file based on an instruction from the user application and continuously transmits the data file with the profile ID through the physical layer.

### CROSS REFERENCES TO RELATED APPLICATIONS

The present invention contains subject matter related to Japanese Patent Application JP 2008-018120 filed in the Japan Patent Office on Jan. 29, 2008, the entire contents of which being incorporated herein by reference.

### BACKGROUND OF THE INVENTION

1. Field of the Invention

The present invention relates to a communication apparatus, a communication system, a communication method and a program.

2. Description of the Related Art

A mobile communication system intended to transmit information of a mobile unit to a general-purpose portable terminal owned by a user of the mobile unit is hitherto known as described in Japanese Unexamined Patent Application Publication No. 2005-191819, for example.

### SUMMARY OF THE INVENTION

Recently, it is assumed that a variety of upper level applications are mounted on a communication apparatus, and it is thus necessary for the communication apparatus to compatible with various kinds of upper level applications. However, upon packet transfer in the case where an upper level application is USB, for example, it has been necessary to issue a transaction with a combination of a token packet, a data packet and a handshake packet for every 1-Kbyte data when transferring data from a host to a target. Thus, when transmitting large-size data, communication of token packets and handshake packets, which are other than data packets desired to be transmitted, increases. This increases the data transfer amount and degrades the data transfer speed. Further, because the end of a data file is detected using the handshake packet in the case of USB, transmission/reception of the handshake packet is essential for the end detection, which increases the data transfer amount.

In file transfer in an upper level application layer (FTP), the end of a file can be determined by detecting EOF (end-of-file) in the upper level application layer as to whether transfer of an entire file is completed. However, because data transfer is performed in units of transactions in a TCP layer, which is a lower level layer, the above-described handshake occurs, thus increasing the data transfer amount as in the case of USB described above.

In light of the foregoing, it is desirable to provide a novel and improved communication apparatus, communication system, communication method and program capable of improving data transfer efficiency in spite of large-size data communication.

According to an embodiment of the present invention, there is provided a communication apparatus including a physical layer to perform signal transmission/reception with another communication end, and a data transfer section to connect an upper level layer and the physical layer, wherein the data transfer section includes an identification information addition section to add identification information indicating a type of data to transmission data based on an instruction from the upper level layer, and the physical layer continuously transmits/receives the data containing the identification information.

In the above configuration, signal transmission/reception with another communication end is performed by the physical layer, and a connection between an upper level layer and the physical layer is performed by the data transfer section. The data transfer section includes the identification information addition section to add identification information indicating the type of data to transmission data based on an instruction from the upper level layer. The data to which the identification information is added is continuously transmitted/received by the physical layer. Because the physical layer continuously transmits/receives the data containing the identification information, there is no need to transmit data in units of transactions, thereby improving data transfer efficiency.

Further, the data transfer section may include an identification information acquisition section to acquire the identification information from the data received through the physical layer and recognize a type of the received data. In this configuration, it is possible to recognize the type of the received data based on the identification information.

The identification information may be information indicating one of that the transmission data continues, that the transmission data is last data, and that the transmission data is a control command for controlling the data transfer section. In this configuration, the other communication end that receives the data can recognize that the transmission data continues, that the transmission data is last data, or that the transmission data is a control command for controlling the data transfer section based on the identification information.

Further, the data transfer section may include a file reception completion notification section to give a file reception completion notification to the upper level layer when the identification information acquisition section acquires the identification information indicating last data. In this configuration, because the file reception completion notification is supplied when the identification information indicating last data is acquired, the upper level layer can recognize that communication ends.

Furthermore, the data transfer section may include an error notification section to give an error notification to the upper level layer if next data is not received within a prescribed time when the identification information acquisition section acquires the identification information indicating that the transmission data continues. In this configuration, because the error notification is supplied to the upper level layer if the next data is not received within a prescribed time when the data continues, the upper level application can recognize the occurrence of an error.

According to another embodiment of the present invention, there is provided a communication system including communication apparatus performing communication with each other, the communication apparatus including a physical layer to perform signal transmission/reception with another communication end, and a data transfer section to connect an upper level layer and the physical layer, wherein the data transfer section includes an identification information addition section to add identification information indicating a type of data to transmission data based on an instruction from the upper level layer, and an identification information acquisition section to acquire the identification information from the data received through the physical layer and recognize a type of the received data, and the data transfer section continuously transmits/receives the data containing the identification information through the physical layer.

In the above configuration, in the communication system where communication apparatus perform communication with each other, signal transmission/reception with another communication end is performed by the physical layer, and a connection between an upper level layer and the physical layer is performed by the data transfer section in the communication apparatus. The data transfer section includes the identification information addition section to add identification information indicating the type of data to transmission data based on an instruction from the upper level layer. The data to which the identification information is added is continuously transmitted by the physical layer. By continuously transmitting the data containing the identification information, this eliminates the need to transmit data in units of transactions, thereby improving data transfer efficiency.

According to another embodiment of the present invention, there is provided a communication method in a communication apparatus including a physical layer to perform signal transmission/ reception with another communication end and a data transfer section to connect an upper level layer and the physical layer, the method including the steps of adding identification information indicating a type of data to transmission data based on an instruction from the upper level layer, and transmitting the data containing the identification information continuously to another communication apparatus through the physical layer.

In the above configuration, in the communication method in the communication apparatus including the physical layer to perform signal transmission/reception with another communication end and the data transfer section to connect the upper level layer and the physical layer, the identification information indicating the type of data is added to the transmission data based on an instruction from the upper level layer, and the data to which the identification information is added is continuously transmitted to another communication apparatus through the physical layer. By continuously transmitting the data containing the identification information, this eliminates the need to transmit data in units of transactions, thereby improving data transfer efficiency.

According to another embodiment of the present invention, there is provided a program in a communication apparatus including a physical layer to perform signal transmission/reception with another communication end and a data transfer section to connect an upper level layer and the physical layer, the program causing a computer to function as a means to add identification information indicating a type of data to transmission data based on an instruction from the upper level layer, and a means to transmit the data containing the identification information to another communication apparatus through the physical layer.

In the above configuration, in the program in the communication apparatus including the physical layer to perform signal transmission/reception with another communication end and the data transfer section to connect the upper level layer and the physical layer, the identification information indicating the type of data is added to the transmission data based on an instruction from the upper level layer, and the data to which the identification information is added is continuously transmitted to another communication apparatus through the physical layer. By continuously transmitting the data containing the identification information, this eliminates the need to transmit data in units of transactions, thereby improving data transfer efficiency.

According to the embodiments of the present invention described above, it is possible to improve data transfer efficiency in spite of large-size data communication.

### BRIEF DESCRIPTION OF THE DRAWINGS

FIG. 1 is a schematic diagram showing two devices constituting a wireless communication system according to an embodiment.

FIG. 2 is a schematic diagram showing the structure of each of the initiator and the responder as a hierarchical structure.

FIG. 3 is a schematic diagram showing data flow in the initiator and the responder.

FIG. 4 is a schematic diagram showing the structure of FIG. 2 as the OSI reference model.

FIG. 5 is a schematic diagram showing data flow of transmission/reception of a file and data in each layer in the device.

FIG. 6 is a schematic diagram showing a logical channel by CSDU.

FIG. 7 is a schematic diagram showing the way that CSDU is mapped.

FIG. 8 is a schematic diagram showing the hardware configuration of the devices.

FIG. 9 is a schematic diagram showing a packet of transmission data.

FIG. 10 is a schematic diagram showing a packet of transmission data.

FIG. 11 is a schematic diagram showing a packet of transmission data.

FIG. 12 is a flowchart showing transmission processing in DTL of the initiator.

FIG. 13 is a flowchart showing reception processing in DTL of the responder.

FIG. 14 is a schematic diagram showing the way of transmitting data continuously from the initiator.

FIG. 15 is a schematic diagram showing access points of services provided by respective layers and a relationship among the layers.

FIG. 16 is a schematic diagram showing state transition in a system of an embodiment.

FIG. 17 is a schematic diagram showing negotiation processing.

FIG. 18 is a schematic diagram illustrating PCL version information.

FIG. 19 is a schematic diagram showing a sequence of emulation selection.

FIG. 20 is a schematic diagram showing services of PCL emulation.

FIG. 21 is a schematic diagram showing services of PCL emulation.

FIG. 22 is a schematic diagram showing packet transfer when an upper level application is USB.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

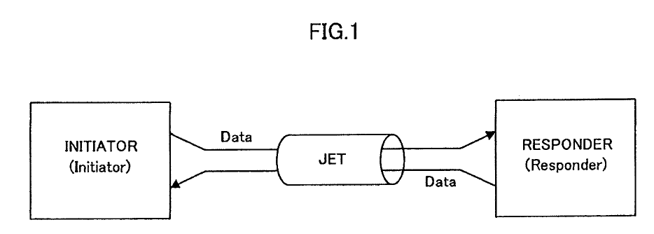

A wireless communication system according to an embodiment employs a communication scheme designed to transmit and receive data between a pair of devices, and it performs wireless data transmission/reception between the devices in the near field. FIG. 1 is a schematic diagram showing two devices (communication apparatus) that constitute the wireless communication system according to the embodiment. The two devices serve as a responder and an initiator, respectively. The initiator is “the end of making a connection request”, and the responder is “the end of receiving the connection request”, and one-to-one or peer-to-peer (P2P) communication is performed in this embodiment. Although the initiator makes a connection request and the responder enters a wait state at the time of connection, they play different roles at the time of connection only, and the two devices have the same configuration related to connection. The initiator may be a personal computer, a portable device, an electronic card or the like, and the responder may be also a personal computer, a portable device, an electronic card or the like.

FIG. 1 schematically shows the way that wireless communication is performed through physical layers included in the respective devices according to the embodiment. Although a physical layer called JET is used as an example in this embodiment, the physical layer is not limited thereto, and a general-purpose physical layer for communication may be used. The JET physical layer is particularly suitable for bulk data communication such as photographs and motion videos by use of a profile ID, CSDU and so on, which are described later. In the following description, the initiator and the responder may be referred to collectively as the JET device (or simply as JET).

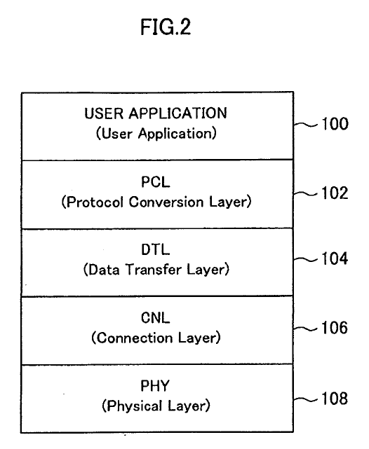

FIG. 2 is a schematic diagram showing the structure of each of the initiator and the responder as a hierarchical structure in the wireless communication system according to the embodiment. Referring to FIG. 2, a user application 100, a protocol conversion layer (PCL) 102, a data transfer layer (DTL) 104, connection layer (CNL) 106, and a physical layer 108 are formed sequentially from the upper level layer in this embodiment.

The user application 100 corresponds to an upper layer protocol (e.g. USB, TCP/IP, OBEX etc.) for performing data communication using services provided by software in upper level layers of the physical layer 108 in the device including the physical layer 108 and capable of the near-field wireless communication according to the embodiment, or an application (e.g. OS such as Windows (registered trademark) and Linux) that performs device control including JET such as a user interface (Ul). In the JET device, such an upper layer protocol or a user application is not particularly specified, and it may be set freely by a user (maker) that configures the device. Thus, each device may include a plurality of upper layer protocols or user applications 100.

The PCL 102 (protocol conversion section) supports a protocol conversion function that converts an arbitrary protocol (USB, TCP/IP, OBEX etc.) that is used by a user who configures the device into a unique JET protocol. A plurality of kinds of protocols are thus passed to the physical layer (PHY) 108 of JET, thereby supporting a variety of protocols. Even for the same USB, protocol conversion may be different depending on a difference in OS such as Windows and Linux. The PCL 102 performs processing to convert contents data such as audio and video generated by the upper level user application 100 and other protocol data and command into a data format that can be handled by the lower level DTL 104. Further, the PCL 102 performs processing that is necessary for JET communication, such as connection, disconnection, device authentication, operation mode setting and initialization.

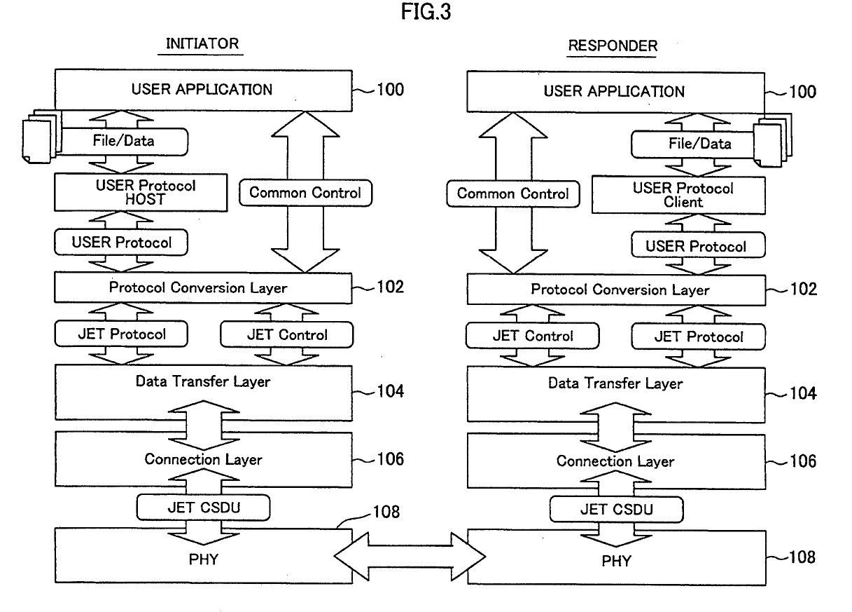

FIG. 3 is a schematic diagram showing data flow in the initiator and the responder. Referring to FIG. 3, the user application 100 performs two kinds of control: connection by JET and data transfer. In JET, the uppermost level PCL 102 provides a service necessary for implementing those functions and performs conversion into a unique JET protocol and connection control. Further, data is passed to the DTL 104 and the CNL 106 that generate a CNL service data unit (CSDU) in conformity to JET standards.

The DTL 104 shapes the data received from the upper level PCL 102 into a prescribed packet structure and performs transmission between the initiator and the responder using a service provided by the lower level CNL 106. In data reception, the DTL 104 analyzes the data received by the CNL 106, extracts CSDU, and passes its payload to the upper level PCL 102. The CSDU contains status information that can be used in the user application 100 other than communication by the physical layer (PHY) 108, and the DTL 104 performs generation and error notification of such data as well.

The DTL 104 can shape the data input from the upper level into a DTL packet regardless of the type of the upper layer protocol and pass it to the lower level CNL 106, and extract a DTL packet from the received data from the lower level and passes the payload of the DTL packet to the upper level. However, although the DTL 104 can receive data transmitted from a different protocol from the PCL 102, it is necessary in JET to disconnect a session once for data transmission/reception of a different protocol, and therefore the use of a DTL service in a plurality of protocols is not performed.

Because of such a limitation, even if data is input from a plurality of PCL emulations to the DTL 104, the DTL 104 does not perform data Mux. Further, even if received data from the CNL 106 contains a plurality of protocols, the DTL 104 does not perform processing such as analysis of the respective protocols, delivery to the PCL 102 according to the contents of the respective protocols and disconnection of a session by error detection.

Therefore, it is necessary for the PCL 102 that uses the service by the DTL 104 to use the service by the DTL 104 in the state that a protocol to be used is fixed to one kind. A PCL common, which is described later, makes determination for fixing a protocol type and performs necessary transmission/reception, and a PCL emulation performs generation and parsing of protocol data. The PCL common also performs exclusive processing for inhibiting the simultaneous use of a DTL service from a plurality of protocols.

The DTL 104 provides a service necessary for the PCL common to establish a connection and a service necessary for the PCL emulation to transmit/receive data after the connection is established.

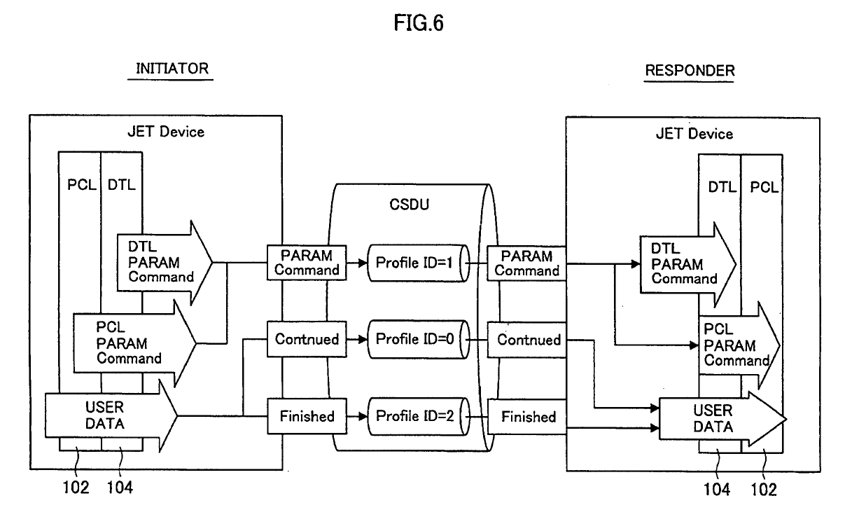

Further, the DTL 104 receives a profile ID, which indicates whether the currently executed service is halfway data or last data of an entire transfer size or whether it is a parameter rather than data, and a size as a parameter from the PCL 102 and inserts it into a CSDU packet header that is generated using a lower level CNL service. The DTL 104 embeds a transmission parameter in a part of a CSDU packet that is generated when transmitting data by JET, thereby implementing a plurality of logical channels as shown in FIG. 6 in one physical layer (PHY) 108.

The DTL 104 has a function to generate a CSDU packet specified in the JET standards. The DTL 104 adds a parameter indicating the type of a CSDU packet to a CSDU packet header. A parameter to be added includes a profile ID, a size and a data payload.

The DTL 104 performs data transfer in units of CSDU provided by the CNL 106. The DTL 104 adds the following three kinds of profile IDs (T_DATA, LT_DATA, CNL_DATA) to CSDU when transmitting CSDU. When receiving CSDU, the DTL 104 performs processing according to the kind of the profile ID.

### T_DATA, LT_DATA

The DTL 104 adds T_DATA (profile ID=0) to the CSDU that transfers user data. However, if it is the last CSDU in the division to a CSDU payload, the DTL 104 adds LT_DATA (profile ID=2). Only user data is stored in the CSDU payload, and the DTL 104 does not embed header information or the like.

### CNL_DATA

The DTL 104 adds CNL_DATA (profile ID=1) to the CSDU that transfers control data specific to a JET system. An example of control data is parameter information or the like.

Header information (specifically, TBD) is embedded in the CSDU payload. The DTL 104 interprets the header information and performs appropriate processing. The CNL 106 performs communication using the service of the physical layer 108 in response to a request from the upper level DTL 104 and further performs establishment or disconnection of a connection of the physical layer 108, ensuring data continuity and so on.

The physical layer 108 is a JET physical layer of the wireless communication system capable of near-field bulk communication according to the embodiment, and it has an error correcting function and a preamble sense function.

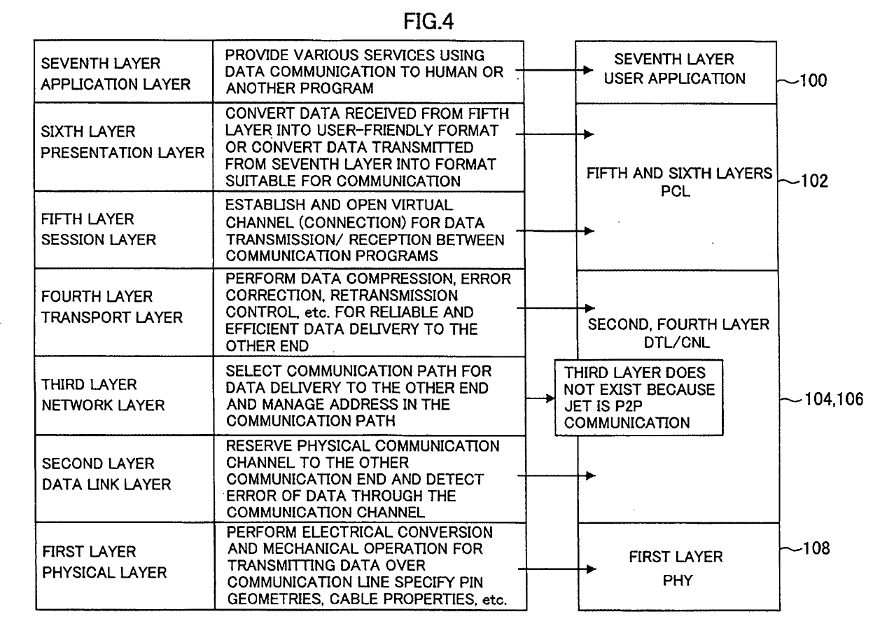

FIG. 4 shows the structure of FIG. 2 as the OSI reference model based on the role of software of the device on which the JET device is mounted. Referring to FIG. 4, the physical layer (first layer) 108 performs electrical conversion and mechanical operation for transmitting data over a communication line. Further, pin geometries and cable characteristics and so on are specified in the first layer.

The DTL 104 and the CNL 106 correspond to a data link layer (second layer) and a transport layer (fourth layer). The data link layer reserves a physical communication channel with the other communication end and detects an error of data flowing through the communication channel. The transport layer performs data compression, error correction, retransmission control and so on for reliably and efficiently delivering data to the other end. Because the system of this embodiment is P2P communication, a network layer (third layer) in the OSI reference model is not placed, thereby simplifying the system.

The PCL 102 corresponds to a session layer (fifth layer) and a presentation layer (sixth layer). The session layer establishes and opens a virtual channel (connection) for transmitting and receiving data between commutation programs. The presentation layer converts data received from the session layer into a user-friendly format or converts data transmitted from an application layer into a format suitable for communication.

The user application 100 corresponds to an application layer (seventh layer). The application layer provides various services using data communication to human or another program.

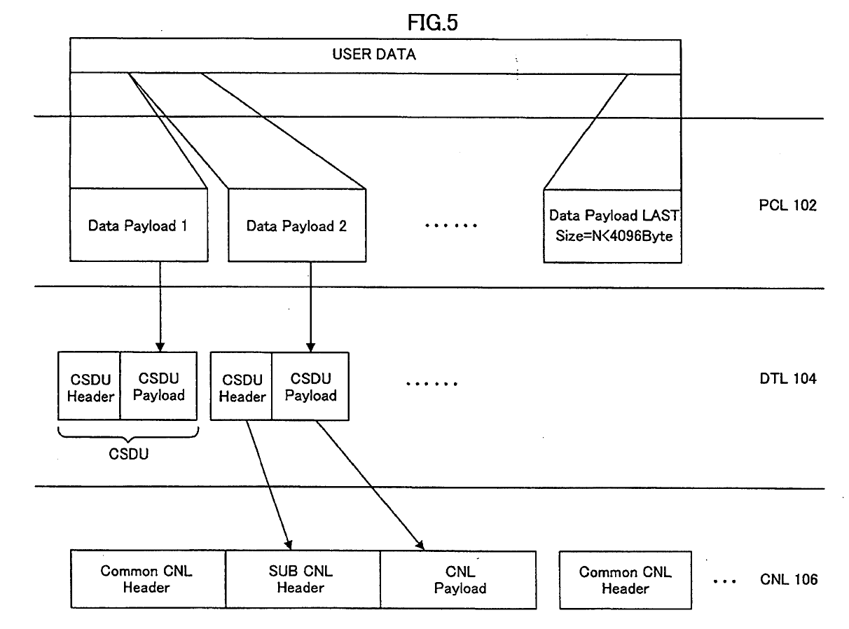

Data flow in the communication apparatus according to the embodiment is described hereinafter. FIG. 5 is a schematic diagram showing data flow, and it illustrates data flow of transmission/reception of a file and data in each layer inside the JET device. The PCL 102 has two separate functions: the PCL common and the PCL emulation. The PCL emulation is used for data transfer, and therefore the processing in the PCL 102 shown in FIG. 5 is implemented by the function of the PCL emulation. The CSDU input to the physical layer 108 is specified as a data format, and this is the same for the data format handled by the DTL 104 that generates and analyzes the header information or the like.

Further, as described later, while the PCL common for providing a common function is specified, the PCL emulation depends on system specifications according to each protocol because it performs data conversion based on a user protocol.

In JET communication, transmission/reception of not only data such as a file but also a control parameter in the PCL 102 and the DTL 104 and data with the same layer at the other communication end exist. Such a file and a parameter are finally transmitted in a format in conformity to a CSDU format by the CNL 106. FIG. 6 is a schematic diagram showing a logical channel by CSDU. Referring to FIG. 6, a profile ID is used for identifying the type of data. It is thereby possible to use a plurality of transmission channels logically in the level of the physical layer 108. This significantly improves a communication rate and it is thus suitable for bulk data communication such as motion videos.

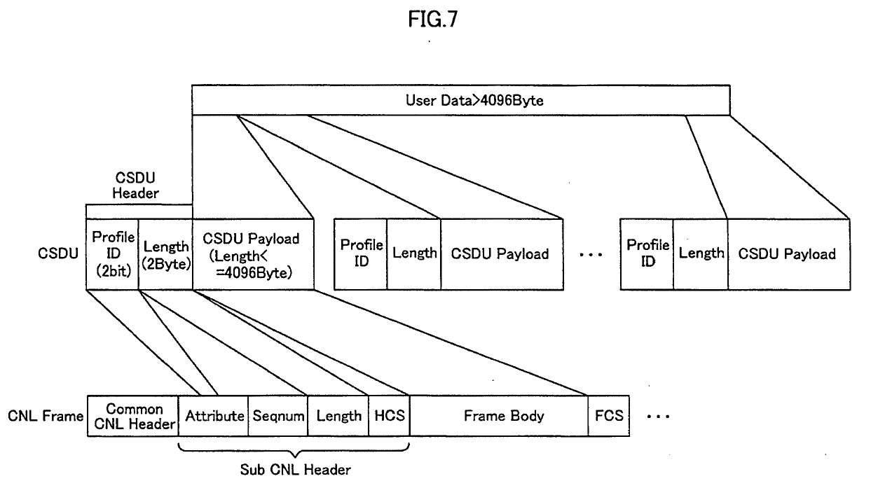

FIG. 7 is a schematic diagram showing the way that CSDU is mapped. The CSDU is a data unit that is exchanged between the CNL 106 and the DTL 104, and it is mapped into a CNL frame as shown in FIG. 7. A user data size transmitted and received by the user application 100 is not particularly specified. If a data length exceeds a data division length (maximum 4096 bytes), the PCL 102 divides the data into a plurality of CSDU payloads. The PCL 102 calls a DTL service in units of CSDU payloads and transmits and receives user data. The DTL 104 adds a header to a CSDU payload and passes it to the lower level CNL 106. The CSDU header is made up of a profile ID and a length indicating the length of the CSDU payload.

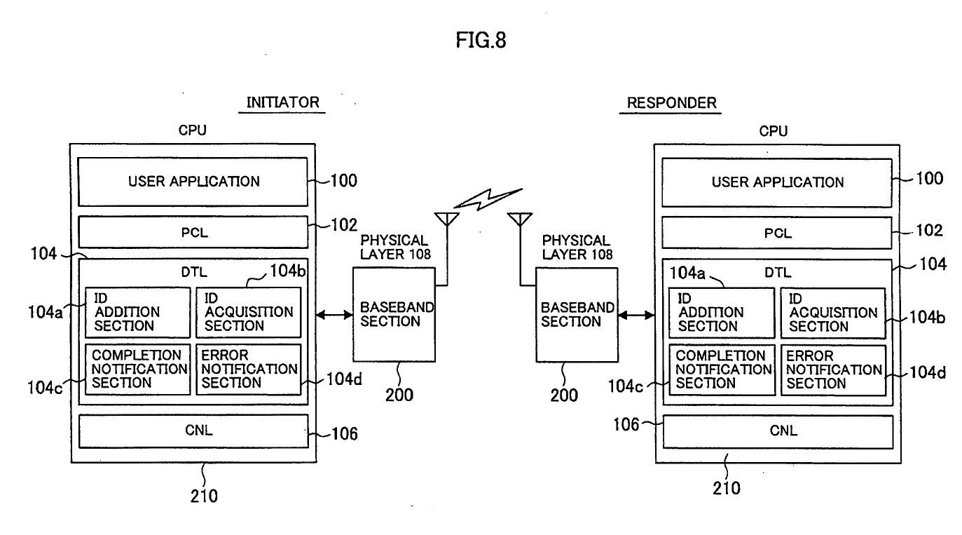

FIG. 8 is a schematic diagram showing the hardware configuration of the devices of the present system. Referring to FIG. 8, each of the initiator and the responder includes a chip 200 forming the physical layer 108 and a CPU 210. The physical layer 108 includes a baseband section. The above-described user application 100, the PCL 102, the DTL 104 and the CNL 106 are implemented by causing the CPU 210 to function using software (program). The software is stored in a memory included in the communication apparatus constituting the initiator and the responder, a recording medium outside the communication apparatus and so on.

Referring to FIG. 8, the DTL 104 includes a profile ID addition section 104a that adds the above-described profile ID, a profile ID acquisition section 104b that acquires a profile ID from received data, a file reception completion notification section 104c that gives notification when file reception is completed normally, and an error notification section 104d that notifies an error upon occurrence of a transmission error (disconnection of communication).

The above-mentioned profile ID and the processing therefor are described hereinbelow. As described with reference to FIG. 7, the DTL 104 adds a CSDU header to a CSDU payload. The CSDU header is composed of a profile ID and a data size (data length). The profile ID is set to any value of 0, 1 or 2.

The value of the profile ID indicates the type of data transmitted from the upper level layer. Profile ID=0 indicates that there is a continuation to transmission data. Profile ID=1 indicates that a DTL command is being transmitted. Profile ID=2 indicates that it is the last of transmission data.

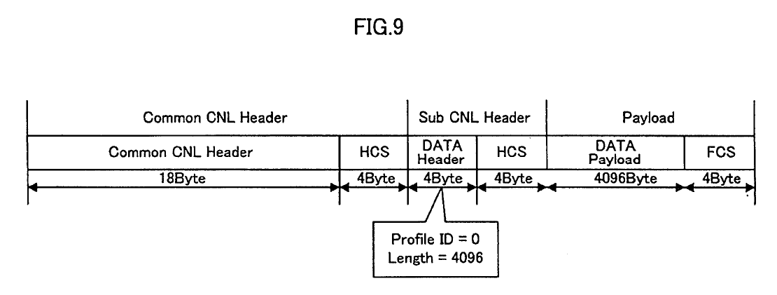

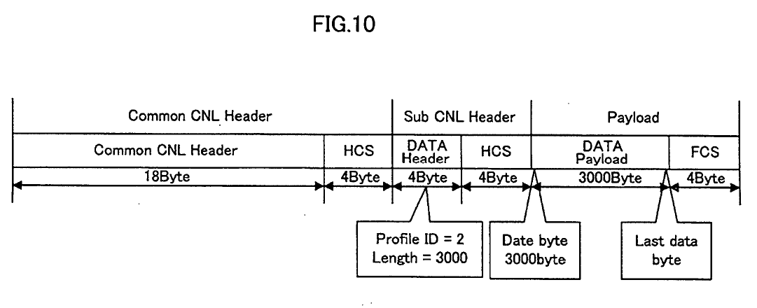

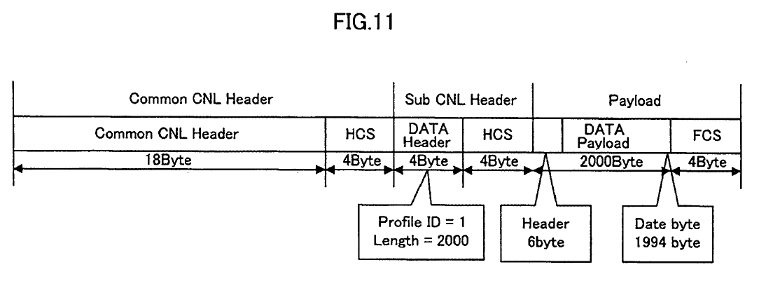

FIGS. 9 to 11 are schematic diagrams showing a packet of transmission data. FIG. 9 shows the case of profile ID=0, FIG. 10 shows the case of profile ID=2, and FIG. 11 shows the case of profile ID=1.

Referring to FIGS. 9 to 11, the profile ID is stored together with a data size (length) in a DATA header in a sub CNL header in a CSDU header. In the example of FIG. 9, because the profile ID is 0, it is indicated that there is a continuation to a transmission data file after transmitting the data payload of 4096 bytes. Thus, by detecting profile ID=0, the responder can recognize that data is transmitted subsequently and thereby prepare to receive the subsequent data.

In the example of FIG. 10, because the profile ID is 2, it is indicated that the data payload of 3000 bytes is the last of a transmission data file. Thus, by detecting profile ID=2, the responder can recognize that transmitted data is the last data.

In the example of FIG. 11, because the profile ID is 1, it is indicated that transmitted data is parameter information such as a DTL command. Thus, by detecting profile ID=1, the responder can recognize that transmitted data is parameter information such as a DTL command and thereby perform appropriate processing according to the parameter information.

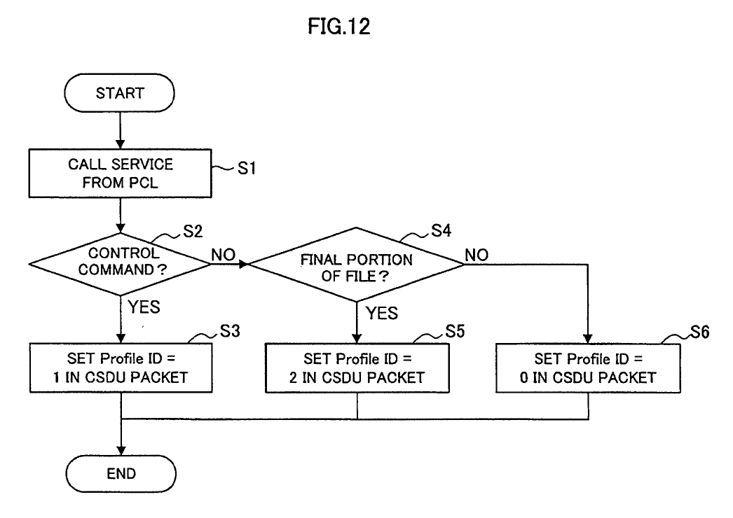

Transmission processing in the DTL 104 of the initiator is described hereinafter with reference to FIG. 12. First, the PCL 102, which is the upper level layer as shown in FIGS. 5 and 7, in the initiator determines whether user data to be transmitted is larger than 4 Kbytes. If the user data exceeds 4 Kbytes, the data is divided into data pieces of 4 Kbytes-each, thus generating a plurality of CSDU payloads.

In the step S1, the service of the DTL 104 is called from the PCL 102, which is the upper level layer. When calling the service of the DTL 104, the upper level layer (PCL 102) notifies the DTL 104 of as to whether the data to be transmitted is halfway data or last data of a plurality of CSDU payloads, or a control command. The DTL 104 adds a CSDU header composed of a profile ID and a data size to a CSDU payload and passes it to the lower level layer.

In the step S2, the DTL 104 determines whether the transmission data is a control command based on the notification from the PCL 102. If the transmission data is a control command, that is when a command for control is inserted into the CSDU payload, the process proceeds to the step S3 and sets the value of the profile ID to “1” and forms a CSDU packet. If, on the other hand, the transmission data is not a control command, the process proceeds to the step S4.

In the step S4, the DTL 104 determines whether the transmission data is the final portion of a file. If it is the final portion of a file, the process proceeds to the step S5 and sets the value of the profile ID to “2” for the last data of the payload and forms a CSDU packet. If, on the other hand, the transmission data is not the final portion of a file, the transmission data continues, and thus the process proceeds to the step S6 and sets the value of the profile ID to “0” and forms a CSDU packet.

The CNL 106, which is the lower level layer of the DTL 104, transmits the CSDU packet to which the value of the profile ID is set as described above continuously one after another to the responder via the physical layer 108.

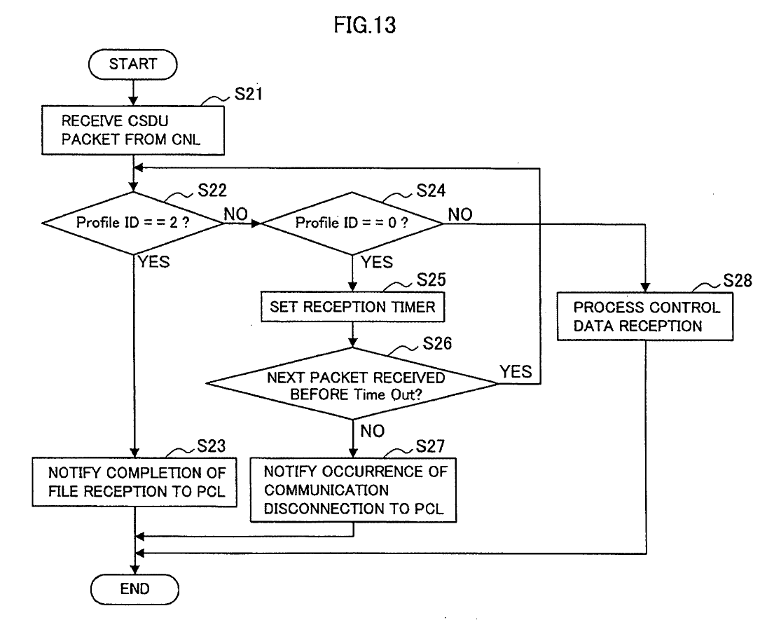

Reception processing in the DTL 104 of the responder is described hereinafter with reference to FIG. 13. The DTL 104 in the responder receives a CSDU packet from the lower level CNL 106 in the step S21. At this time, the DTL 104 refers to the profile ID of the CSDU packet and determines whether there is a subsequent data file based on the profile ID. Specifically, in the step S22, the DTL 104 determines whether the value of the profile ID is 2, and if profile ID=2, the process proceeds to the step S23. If the CSDU packet of profile ID=2 is received, the received data is the final portion of the file, which means that reception of all the necessary data is completed. Thus, in the step S23, the DTL 104 notifies completion of file reception to the upper level PCL 102 and passes the received data as user data to the PCL 102.

On the other hand, if the profile ID is not 2 in the step S22, the process proceeds to the step S24. In the step S24, the DTL 104 determines whether the value of the profile ID is 0, and if profile ID=0, the process proceeds to the step S25. Because there is subsequent data in this case, a reception timer is set in the step S25 to enter a reception wait state. In the following step S26, the DTL 104 determines whether the next packet is received before time out of the reception timer, and if the next packet is received before time out, the process returns to the step S22 and performs the subsequent processing again.

On the other hand, if the next packet is not received before time out in the step S26, the process proceeds to the step S27. Because the reception of the packet transmitted continuously from the initiator fails for some reason in this case, the DTL 104 determines that communication is disconnected and notifies this to the upper level PCL 102 in the step S27, and ends the processing. Receiving the notification, the PCL 102 performs error handling such as data protection or discard of a corrupted file in the middle of transfer.

If the profile ID is not 0 in the step S24, the process proceeds to the step S28. Because profile ID=1 in this case, reception processing of control data is performed in the step S28, and the internal processing of the DTL 104 is conducted based on the control data.

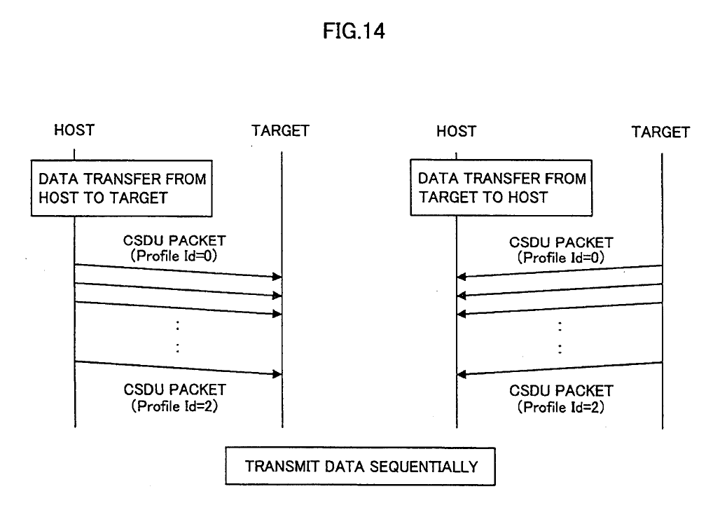

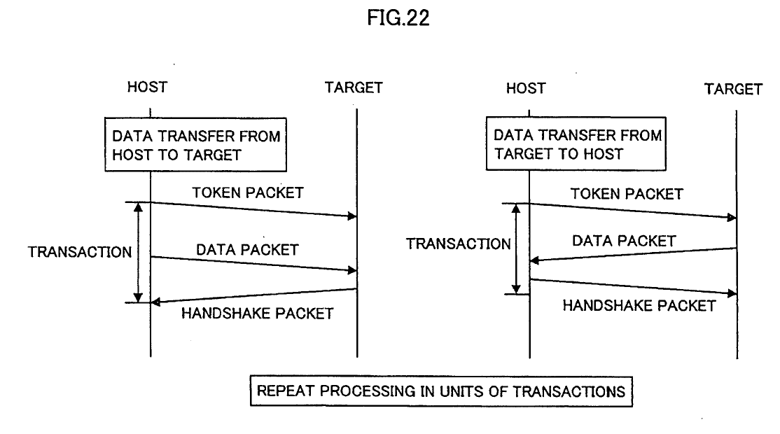

In USB communication according to a related art, for example, a large number of transactions are necessary when performing large-size data communication, which degrades the transfer efficiency and speed (cf. FIG. 22) On the other hand, according to the processing using the profile ID of this embodiment, because the transmission data contains the profile ID indicating the last of transfer data, it is possible to transfer the data continuously from the initiator (host) to the responder (target) as shown in FIG. 14, thereby enabling reduction of ancillary communication for transfer such as token packets and handshake packets. Further, it is possible to determine whether communication is performed normally based on the profile ID without the need to consider how many bytes of the entire transmission data have been transmitted up to the present, thereby enabling simple processing that continuously transmits packets to which the profile ID is added.

Further, the responder can detect that transfer is completed or not completed in the lower level layer close to the physical layer 108 by referring to the profile ID. It is thereby possible to recognize completion of transfer in the lower level than the user application 100 and pass the received data file to the upper level layer. If transfer is not completed, it is possible to notify the occurrence of an error in communication to the upper level layer.

Furthermore, by setting a reception waiting time between CSDU packets, if reception time out occurs when data with the profile ID indicating a final packet is not received, it can be detected that transfer is terminated incompletely, thereby facilitating immediate transition to error handling in the lower level layer close to the physical layer 108.

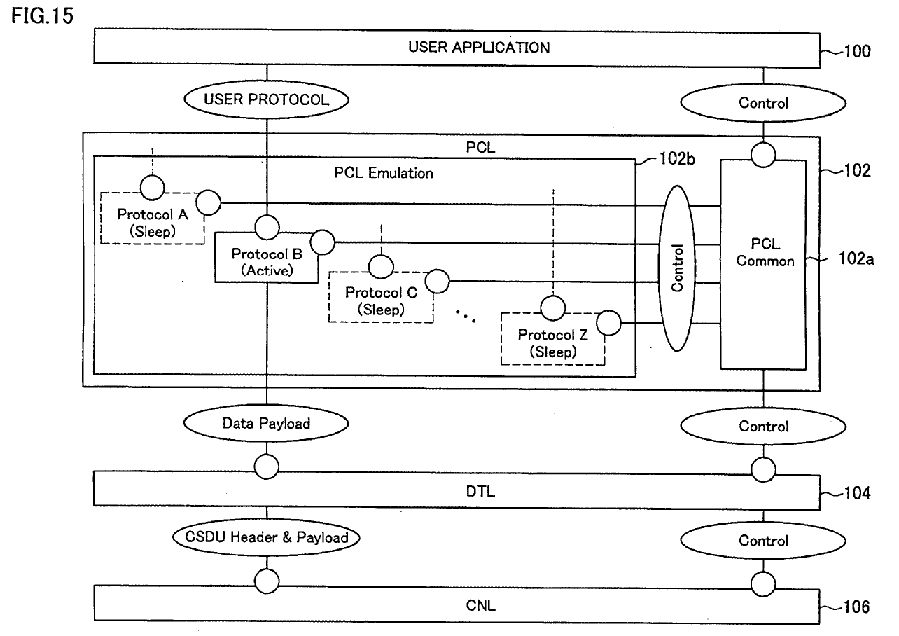

FIG. 15 is a schematic diagram showing access points of services provided by the respective layers and a relationship among the layers. The upper level of the PCL 102 is the user application 100. The PCL 102 is a layer that provides a service using the lower level DTL 104. Because the PCL 102 plays two separate roles with respect to the upper level user application 100: a PCL common 102a (common processing section) for control and a PCL emulation 102b (conversion processing section) for data transfer, the services of the PCL 102 are specified for the respective sections.

The PCL common 102a provides the following services by calling connection/ disconnection/other control services of the DTL 104 in response to a request from the user application 100:

a control service such as connection and disconnection;

an event notification service such as an error; and

an emulation control service.

The service by the PCL emulation 102b exists individually for a corresponding protocol. Each PCL emulation is a protocol service that enables communication by superimposing command or data of a general-purpose protocol (USB, TCP/IP, OBEX etc.) on a CSDU payload.

In the PCL 102, only the service corresponding to the protocol type selected by the PCL emulation service is allowed to start. Inside the PCL emulation service, a CSDU payload for using the service by the DTL 104 is generated according to a request from the upper layer protocol. With a plurality of services by the PCL emulation 102b, it is possible to implement a plurality of emulation services in one JET device. The PCL common 102a makes control so that the emulation service that can be used in one-time session is only one kind.

Referring to FIG. 15, the PCL 102 implements two separate functions by the PCL common 102a and the PCL emulation 102b. The PCL common 102a provides basic functions such as initialization of the service of the lower level layer, connection and disconnection according to a request from the upper level user application 100. Because the PCL common 102a performs processing of the basic functions, the same processing is performed regardless of which protocol is selected. On the other hand, the PCL emulation 102b converts an arbitrary protocol held by the user application 100 into a protocol format that is handled by the lower level DTL 104 and the CNL 106 after completing the startup by the PCL common 102a.

As described above, the PCL common 102a provides common function services such as initialization and basic communication (connection, disconnection, device authentication) to the user application 100. The PCL common 102a is software that is installed commonly in all JET devices. Thus, the PCL 102 does not operate in the configuration with the PCL emulation 102b only.

The PCL emulation 102b performs transfer of user data after a connection is established by the PCL common 102a, and it converts a user protocol (general-purpose protocol data such as USB, TCP/IP and OBEX) into a data format to be handled by the DTL 104. Specifically, the PCL emulation 102b converts user protocol data that is transmitted from the user application 100 into a format that can be interpreted by the lower level DTL 104. An emulation block (a conversion module of the PCL emulation 102b) in the PCL 102 provides a service for providing a data transfer function in the same manner as controlling an existing device such as USB, MSC and NFC when viewed from the user application 100. The number of the PCL emulations 102b corresponds to the number of protocols unique to a user who configures the device.

The DTL 104 provides a function using a service of the lower level CNL 106 as a DTL service to the two kinds of the upper level PCL (the PCL common 102a and the PCL emulation 102b). Although the PCL emulation 102b has different conversion modules (protocol A, protocol B, protocol C, . . . and protocol Z) for different user protocols as described in detail layer, only one kind of conversion module can be used in one-time session (connection), and it is controlled by the PCL common 102a. If the upper level protocol is USB, for example, different conversion modules are prepared for mass storage class and other schemes.

In the JET device, a user who configures the device can build the PCL emulation 102b by freely setting a conversion module corresponding to the upper level protocol. Further, a user can freely add or eliminate a conversion module. On the other hand, because the PCL common 102a is the basic function of protocol conversion, it is mandatory that the PCL common 102a is common among all JET devices.

FIG. 15 shows the protocols A to Z as examples of user protocols, and it illustrates the state where the protocol B is active and a connection is established by the protocol B. In such a case, the connection by the protocol B is performed in both of the initiator and the responder. Which protocol is used for establishing a connection is determined by negotiation between the initiator and the responder.

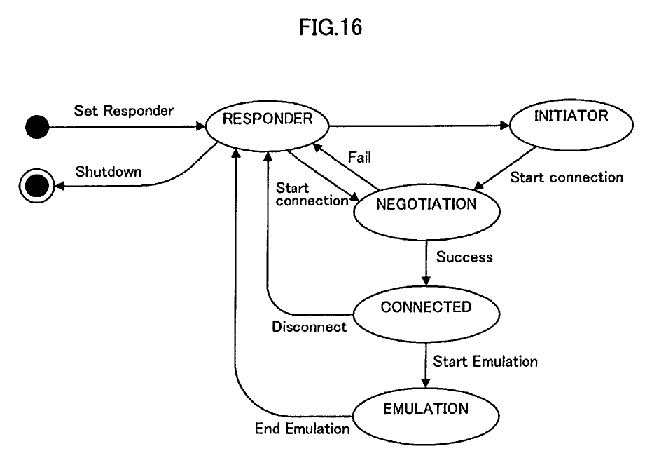

FIG. 16 is a schematic diagram showing state transition in the system of the embodiment. The PCL 102 makes the state transition as shown in FIG. 16 due to change in the connection state between the initiator and the responder by the physical layer 108 or use of the PCL service from the user application 100.

Referring to FIG. 16, the responder first enters a wait state for a connection from the initiator, and the initiator enters a state to search for the responder to be connected with. If a connection between the initiator and the responder is started (“start connection”), negotiation is performed between the initiator and the responder (“negotiation”). In this state, checking of a software version and an emulation type (what protocols are held in each device) is performed between the JET devices.

As a result of the negotiation, if the version and the emulation type match respectively, a connection is established, and thereby a connection by the physical layer 108 ends (“connected”). After that, emulation is started (“emulation”), and data transfer is enabled between the user applications 100. On the other hand, if the software version information does not match, or if the protocols held in each device does not match and thus the emulation type does not match, a connection is not established (“disconnect”). When a connection is not established (“disconnect”) or when the emulation ends (“end emulation”), the responder enters a connection wait state.

The PCL common 102a has a negotiation function that performs version check and emulation type determination based on the version information of the PCL 102. As a result of the negotiation, if the version and the emulation type match, a connection by the same protocol is established between the initiator and the responder. A version management function (PCL version management) and an emulation determination function (PCL select emulation) necessary for the negotiation are described later. The negotiation is not a service that is provided to the user application 100 but an internal function that is automatically executed upon detection of a connection during the connection wait state.

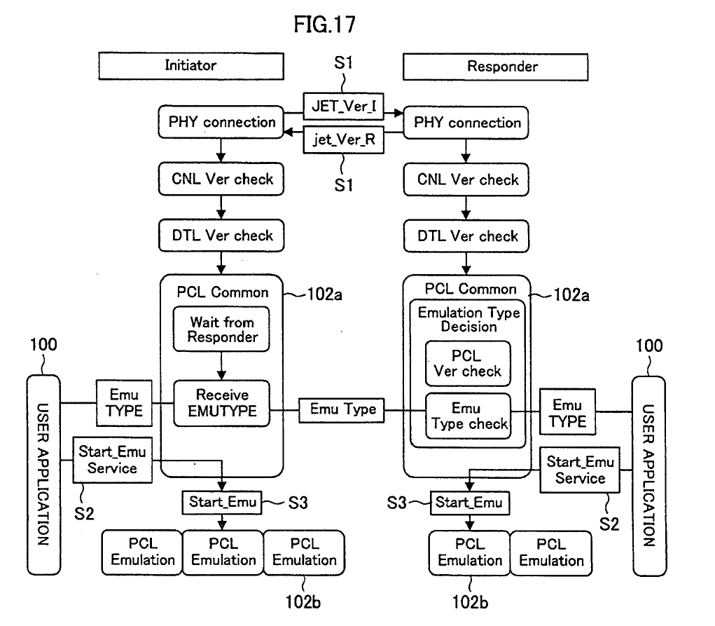

FIG. 17 is a schematic diagram showing negotiation processing. The processing shown in FIG. 17 can be implemented by causing the CPU 210 to function using the software of each layer in FIG. 2. As an example, the responder performs determination, and the initiator waits for the determination result. The version information of the device to be connected with is acquired by the CNL 106, and the version information is automatically converted at the time of connection (step S1). The version information converted at this time is referred to as the JET version.

In the PCL 102, the JET version information of the JET device to be connected with is already acquired at the time of detecting the connection by the event from the lower level CNL 106 and the DTL 104. Thus, firstly, the software version check of the CNL 106 (CNL Ver check) and the software version check of the DTL 104 (DTL Ver check) are performed as shown in FIG. 17. Further, the emulation type is determined by checking the PCL version contained in the JET version inside the PCL 102.

The determination of the emulation type is performed at the initiative of the responder, for example. The version information of the PCL 102 is exchanged between the initiator and the responder, and the version information of the software of the PCL 102 is checked by the PCL version check function of the PCL common 102a (PCL Ver check).

Then, the emulation type information is exchanged between the initiator and the responder, and the type of the emulation is checked by the emulation type check function of the PCL common 102a as shown in FIG. 17 (EMU Type check). The emulation type is a parameter in which the emulation type (protocol) that can be communicated by the respective JET devices is described.

The responder compares the emulation types of the initiator and the responder and if there is a match, it determines that a connection is possible. Upon determination of the emulation type, the PCL 102 gives notification to the user application 100, and the user application 100 calls PCL_start_emu service (step S2). Then, the PCL common 102a transmits a command Start_Emu to the PCL emulation 102b. The startup by the PCL common 102a thereby ends, and then the emulation by the PCL emulation 102b starts (step S3). The PCL emulation 102b converts the protocol of the user application 100, thereby enabling communication with the lower level DTL 104 and the CNL 106.

In the case where a plurality of the same emulation types are held by the initiator and the responder, the PCL 102 notifies that to the user application 100. If the user application 100 designates one of the plurality of emulation types, such information is transmitted to the PCL 102. At this time, the user application 100 can designate a previously designated one emulation type. Further, in the case where the necessity of using a protocol capable of high-speed communication is relatively low such as when one of the initiator or the responder is a portable device, it is possible to select the emulation type of an appropriate protocol according to a communication speed. Such specifications may be freely set by a user who configures the JET device or the user application 100.

Emulation selection by the PCL 102 is described hereinafter. The emulation selection is a function that is executed inside the PCL common 102a when performing the negotiation in the responder upon connection detection from the initiator. It is checked whether the devices have any matching emulation from the PCL version information in the JET version exchanged between the JET devices at the time of connection.

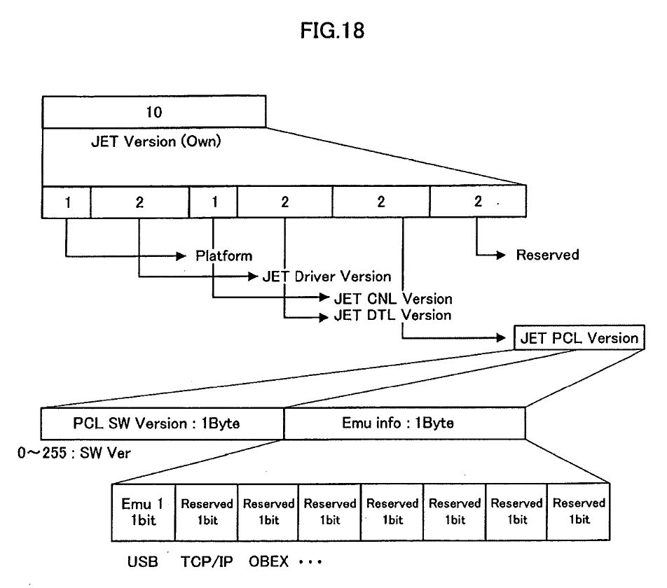

FIG. 18 is a schematic diagram illustrating the JET version information. The PCL 102 manages two pieces of version information: the version information of the own device and the version information of the JET device to be connected with. The version information of the own device is loaded upon startup, and it holds the version information of the device to be connected with at the time of connection detection and during connection.

Referring to FIG. 18, the JET version information is 10 bytes in total, and it contains platform information (1 byte), JET driver version information (2 bytes), CNL version information (1 byte), DTL version information (2 bytes), PCL version information (2 bytes) and reserved (2 bytes) sequentially from the upper level layer.

In the PCL version information (2 bytes), 1 byte in the first half indicates the version No (T.B.D.) of software for maintaining the system compatibility, and 1 byte in the latter half indicates the emulation type supported by the device (JET device). In FIG. 18, USB, TCP/IP, OBEX . . . are shown as examples of the emulation type, and 1-bit data is allocated to each type. The bit of 1 represents that the device supports the emulation type, and the bit of 0 represents that the device does not support the emulation type. Although a maximum value of emulation types supported by one JET device is not particularly regulated, it is necessary to support at least one emulation type.

Checking of the version information is performed sequentially from the information in the upper level layer side (the platform side) of FIG. 18 as shown in FIG. 17. After checking the version information in the PCL 102, checking of the emulation type is performed.

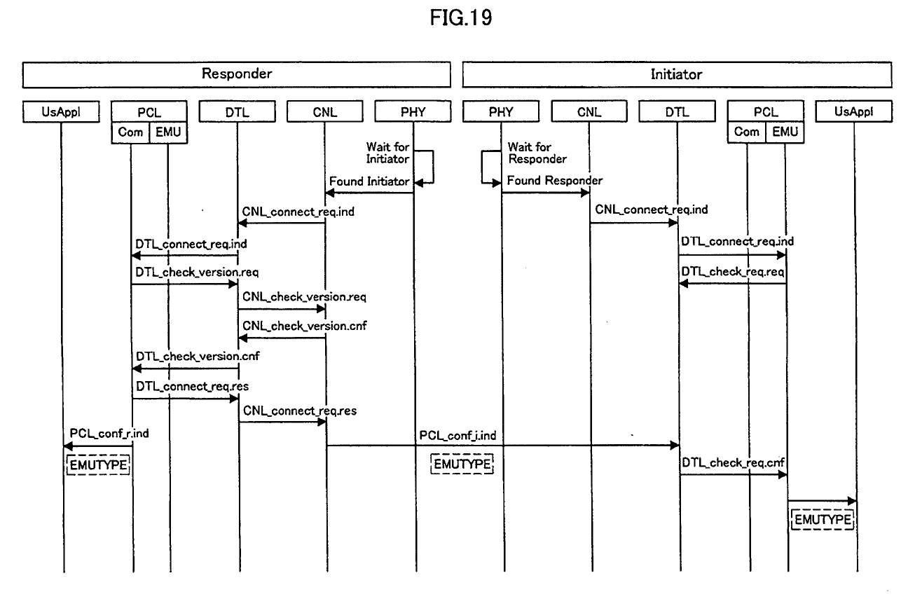

As a result of executing a connection, the emulation type that can be communicated between the devices is selected, and the selected emulation type is supplied from the responder to the user application 100, and also supplied to the initiator waiting for permission. FIG. 19 is a schematic diagram showing the sequence of the emulation selection. Referring to FIG. 19, the selected emulation type (EMUTYPE) is supplied as PCL_conf_r.ind to the user application 100 (UsrAppl) of the responder and supplied as PCL_cnf_i.ind to the initiator.

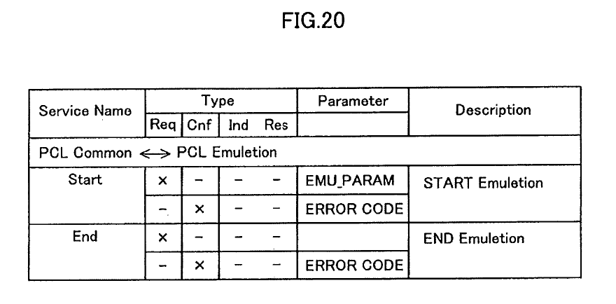

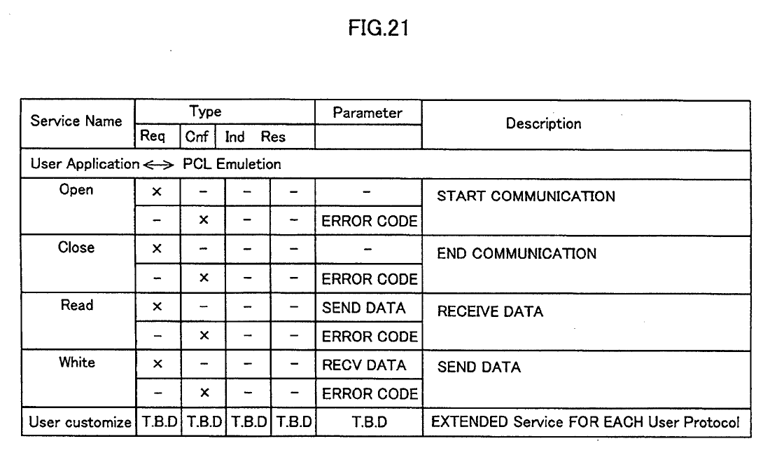

FIGS. 20 and 21 are schematic diagrams showing services related to the PCL emulation 102b. Each service is described hereinafter. Although start and end are performed by the PCL common 102a, data transmission and reception are executed by performing communication from the user application 100 to the PCL emulation 102b. Thus, the service related to the PCL emulation 102b is divided into a service provided with the PCL common 102a (FIG. 20) and a service provided with the user application 100 (FIG. 21).

### Start Service (Mandatory; FIG. 20)

Start service is a service provided as standard, and it provides initialization processing of the PCL emulation 102b that is executed by the PCL common 102a at the time of starting the emulation. Upon completion of Start, data transmission/reception using a user protocol from the user application 100 is enabled.

### End Service (Mandatory; FIG. 20)

End service is a service provided as standard, and it provides end processing of the emulation that is executed by the PCL common 102a at the time of ending the emulation. Upon completion of End, data transmission/reception using a user protocol from the user application 100 is disabled. If the emulation is started, the PCL common 102a executes this service before executing disconnection (PCL_Disconnect).

### Open Service (Mandatory; FIG. 21)

Open service is a service that provides necessary processing at the time of opening a communication channel on a user protocol.

### Close Service (Mandatory; FIG. 21)

Close service is a service that provides necessary processing at the time of closing a communication channel on a user protocol.

### Read Service (Mandatory; FIG. 21)

Read service is a service that provides necessary processing at the time of acquiring data of the device to be connected with on a user protocol.

### Write Service (Mandatory; FIG. 21)

Write service is a service that provides necessary processing at the time of transmitting data to the device to be connected with on a user protocol.

As described above, Open service and Closer service are the processing corresponding to the initialization of the upper layer protocol by the PCL common 102a. Further, Read service and Write service are the processing related to data transmission and reception by the user application 100.

### User Customize Service (Option; FIG. 21)

This is a service that does not correspond to any of the above services, and it can be defined as a unique service by a user who configures the device. The part other than “Open” and “Close” a communication channel and “transmit (Write)” and “receive (Read)” data is a customizable area that can be freely set by a user who configures the JET device, and a user can freely sets it according to the kind (Windows, Linux etc.) of the user application 100, for example. In the use of any application, however, “Start” and “End” by the PCL common 102a are necessary as described above, and they are thus common among all JET devices.

As described in the foregoing, according to the embodiment, because the transmission data contains the profile ID indicating the last of transfer data, it is possible to transmit the data continuously from the initiator, thereby enabling reduction of ancillary communication for transfer such as token packets and handshake packets. Further, the responder can detect that transfer is completed or not completed by referring to the profile ID. It is thereby possible to pass the received data file to the upper level layer when the transfer is completed. When the transfer is not completed, on the other hand, it is possible to notify the occurrence of an error in communication to the upper level layer. Although a wireless communication system is described by way of illustration in the example described above, the communication system may be a wired communication system.

It should be understood by those skilled in the art that various modifications, combinations, sub-combinations and alterations may occur depending on design requirements and other factors insofar as they are within the scope of the appended claims or the equivalents thereof.

What is claimed is:

1. A communication apparatus comprising:
a physical layer to perform signal transmission/reception with another communication end; and
a data transfer section to connect an upper level layer and the physical layer, wherein
the data transfer section includes an identification information addition section to add identification information indicating a type of data to transmission data based on an instruction from the upper level layer, and
the physical layer continuously transmits/receives the data containing the identification information.

2. The communication apparatus according to claim 1, wherein
the data transfer section includes an identification information acquisition section to acquire the identification information from the data received through the physical layer and recognize a type of the received data.

3. The communication apparatus according to claim 1, wherein
the identification information is information indicating one of that the transmission data continues, that the transmission data is last data, and that the transmission data is a control command for controlling the data transfer section.

4. The communication apparatus according to claim 3, wherein
the data transfer section includes a file reception completion notification section to give a file reception completion notification to the upper level layer when the identification information acquisition section acquires the identification information indicating last data.

5. The communication apparatus according to claim 2, wherein
the data transfer section includes an error notification section to give an error notification to the upper level application if next data is not received within a prescribed time when the identification information acquisition section acquires the identification information indicating that the transmission data continues.

6. A communication system including communication apparatus performing communication with each other, the communication apparatus comprising:
a physical layer to perform signal transmission/reception with another communication end; and
a data transfer section to connect an upper level layer and the physical layer, wherein
the data transfer section includes:
an identification information addition section to add identification information indicating a type of data to transmission data based on an instruction from the upper level layer, and
an identification information acquisition section to acquire the identification information from the data received through the physical layer and recognize a type of the received data, and
the data transfer section continuously transmits/receives the data containing the identification information through the physical layer.

7. A communication method in a communication apparatus including a physical layer to perform signal transmission/reception with another communication end and a data transfer section to connect an upper level layer and the physical layer, the method comprising the steps of:
adding identification information indicating a type of data to transmission data based on an instruction from the upper level layer; and
transmitting the data containing the identification information continuously to another communication apparatus through the physical layer.

8. A program in a communication apparatus including a physical layer to perform signal transmission/reception with another communication end and a data transfer section to connect an upper level layer and the physical layer, the program causing a computer to function as a device comprising:
a means to add identification information indicating a type of data to transmission data based on an instruction from the upper level layer; and
a means to transmit the data containing the identification information to another communication apparatus through the physical layer.
